(19) United States
(12) Patent Application Publication
(10) Pub. No.: US 2015/0125624 A1
(43) Pub. Date: May 7, 2015

(54) Spray Application Process for Three Dimensional Articles

(71) Applicant: Tyco Electronics Corporation, Berwyn, PA (US)

(72) Inventors: Forest I. Bohrer, San Bruno, CA (US); Jeanine M.W. Olson, San Jose, CA (US)

(73) Assignee: Tyco Electronics Corporation, Berwyn, PA (US)

(21) Appl. No.: 14/070,424

(22) Filed: Nov. 1, 2013

(51) Int. Cl. H01B 13/00; H01B 1/22

(52) U.S. Cl. CPC H01B 13/003; H01B 13/0026; H01B 1/22; H01B 13/0016
USPC 427/551; 427/554; 427/559; 427/555; 427/560; 427/126.1; 427/125

(57) ABSTRACT

A three-dimensional article having spray-applied ink and a spray application process for three-dimensional articles are disclosed. The article includes a substrate and conductive ink spray-applied to a non-planar region of the substrate. The conductive ink on the non-planar region is at least a portion of a power trace, an antenna, a resistive heater, a conductive lead, a sensor, a functional electrical device, or a combination thereof. The process includes spray-applying conductive ink, ablating the conductive ink, photo-sintering the conductive ink, or a combination thereof.

### FIELD OF THE INVENTION

The present invention is directed to articles having conductive ink and processes of fabricating such articles. More particularly, the present invention is directed to articles having spray-applied conductive ink and processes of spray-applying such conductive inks.

### BACKGROUND OF THE INVENTION

Electronic devices are continuously becoming smaller, more compact, and more complex. Such changes can result in issues with electrical connectivity, deposition, manufacturing, and adhesion to certain materials. Producing antennas and conductive traces capable of operation on or with such electronic devices is, thus, becoming more difficult and/or more costly.

One process of producing antennas is laser direct structuring. Laser direct structuring uses a composite loaded with a laser-activated precursor that acts as a seed layer for selective plating. Laser direct structuring is limited to types of polymers that incorporate a precursor material and limits adhesion to substrates.

Processes of selective plating include application of latex or other adhered masks by hand. Masking for selective plating is costly due to the multi-step batch processing involved, and the manual aspects can lead to substantial scrap and/or quality control issues. In addition, plating can present an environmental health and safety hazard due to caustic hazardous waste.

Other processes for producing antennas include screen printing, flexographic techniques, gravure-printing, spin-coating, and dip-coating, each of which results in distinct physical features. Such processes suffer from drawbacks that such approaches are limited to specific and/or simple geometries (for example, planar geometries), can be very time consuming to achieve desired thicknesses, and can be costly, due to the time-consuming production aspects.

Certain conductive inks have previously been considered to be unsuitable for use as antennas. For example, resistance, and by extension, direct current resistance, of such inks can be significantly higher than a bulk metal (between 40 and 500 times higher). Antenna efficiency has been described as being inversely related to the square root resistivity of a conductive trace. In view of this, dipole antenna efficiency of certain antennas using conductive inks should fall by at least 10% below that of an aluminum control.

An article with spray-applied conductive ink as well as a process of fabricating such an article that do not suffer from one or more of the above drawbacks would be desirable.

### BRIEF DESCRIPTION OF THE INVENTION

In an embodiment, a selectively metalized article includes a substrate and conductive ink spray-applied to a non-planar region of the substrate. The conductive ink on the non-planar region is at least a portion of a power trace, an antenna, a resistive heater, a conductive lead, a sensor, a functional electrical device, or a combination thereof.

In another embodiment, an antenna includes a spray-applied ink that extends over a non-planar region of a substrate.

In another embodiment, an article includes a substrate and an antenna comprising conductive ink spray-applied onto a non-planar region of the substrate.

In another embodiment, a process includes providing a substrate, spray-applying conductive ink onto a non-planar region of the substrate, and ablating the conductive ink or photo-sintering the conductive ink.

In another embodiment, a process of fabricating an antenna includes providing a substrate and spray-applying conductive ink onto a non-planar region of the substrate to form at least a portion of the antenna.

In another embodiment, a process includes providing a substrate and spray-applying conductive ink onto a non-planar region. The conductive ink has an elemental composition, by weight, of 23% polymer matrix and 67% Ag.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of an embodiment of an article having an antenna with a spray-applied conductive ink extending over a 90-degree non-planar region, according to the disclosure.

FIG. 2 illustrates a perspective view of an embodiment of an article having an antenna with a spray-applied conductive ink extending over a 45-degree non-planar region, according to the disclosure.

FIG. 3 illustrates a perspective view of an embodiment of an article having an antenna with a spray-applied conductive ink extending over a 120-degree non-planar region, according to the disclosure.

FIG. 4 illustrates is a perspective view of an embodiment of an article having an antenna with a spray-applied conductive ink extending over a concave non-planar region, according to the disclosure.

FIG. 5 illustrates a perspective view of an embodiment of an article having an antenna with a spray-applied conductive ink extending over a convex non-planar region, according to the disclosure.

FIG. 6 illustrates a perspective view of an embodiment of an article having an antenna with a spray-applied conductive ink extending over a ribbed non-planar region, according to the disclosure.

FIG. 7 illustrates a perspective view of an embodiment of an article having an antenna with a spray-applied conductive ink extending in a spiraling orientation over a conical non-planar region, according to the disclosure.

FIG. 8 illustrates a perspective view of an embodiment of an article having an antenna with a spray-applied conductive ink extending in a radial orientation over a conical non-planar region, according to the disclosure.

FIG. 9 illustrates a perspective view of an embodiment of an article having an antenna with a spray-applied conductive ink extending over a frustoconical non-planar region, according to the disclosure.

FIG. 10 displays dipole efficiency, in units of percent efficiency, of embodiments of spray-applied conductive inks, according to the disclosure.

FIG. 11 displays dipole efficiency, in units of dB, of embodiments of spray-applied conductive inks, according to the disclosure.

FIG. 12 displays insertion loss data for embodiments of spray-applied conductive inks, according to the disclosure.

FIG. 13 displays averages of insertion loss data for embodiments of spray-applied conductive inks, according to the disclosure.

FIG. 14 is a scanning electron micrograph of an embodiment of a spray-applied conductive ink, according to the disclosure.

FIG. 15 is a scanning electron micrograph of an embodiment of a spray-applied conductive ink, according to the disclosure.

FIG. 16 is a scanning electron micrograph of an embodiment of a spray-applied conductive ink after a first pass of a laser, according to the disclosure.

FIG. 17 is a scanning electron micrograph of an embodiment of a spray-applied conductive ink after a second pass of a laser, according to the disclosure.

FIG. 18 displays energy-dispersive X-ray spectra of an embodiment of a spray-applied conductive ink, according to the disclosure.

FIG. 19 displays energy-dispersive X-ray spectra of an embodiment of a spray-applied conductive ink after a first pass of a laser, according to the disclosure.

FIG. 20 displays energy-dispersive X-ray spectra of an embodiment of a spray-applied conductive ink after a second pass of a laser, according to the disclosure.

FIG. 21 is a scanning electron micrograph of an embodiment of a spray-applied conductive ink, according to the disclosure.

FIG. 22 displays energy-dispersive X-ray spectra of the embodiment of the spray-applied conductive ink in FIG. 21, according to the disclosure.

FIG. 23 is a scanning electron micrograph of the embodiment of the spray-applied conductive ink in FIGS. 21-22 after photo-sintering, according to the disclosure.

FIG. 24 displays energy-dispersive X-ray spectra of the embodiment of the spray-applied conductive ink in FIGS. 21-22 after photo-sintering, according to the disclosure.

Wherever possible, the same reference numbers will be used throughout the drawings to represent the same parts.

### DETAILED DESCRIPTION OF THE INVENTION

Provided is an exemplary article having a spray-applied conductive ink and a process of spray-applying conductive ink. Embodiments of the present disclosure, for example, in comparison to similar concepts that fail to include one or more of the disclosed features, include conductive inks that do not have RF insertion loss that is too low in comparison to bulk metal or control samples, are smaller, are more compact, are more complex, have a finer structure, are devoid or substantially devoid of one or more undesirable features of the above-described techniques and components, maintain electrical connectivity, are produced by less complex and/or less costly processes, do not rely upon laser-direct structuring, do not rely upon laser-activated precursors, do not rely upon a seed layer for selective plating, are not limited to specific types of polymers or substrates, do not incorporate a precursor material, permit use of conductive inks having between 30 and 100 times higher direct current resistance than bulk metals, have improved adhesion, decrease hazardous conditions, decrease waste, reduce use of precious metals, permit application on non-planar geometries as well as planar geometries, permit other suitable advantages and distinctions, or combinations thereof.

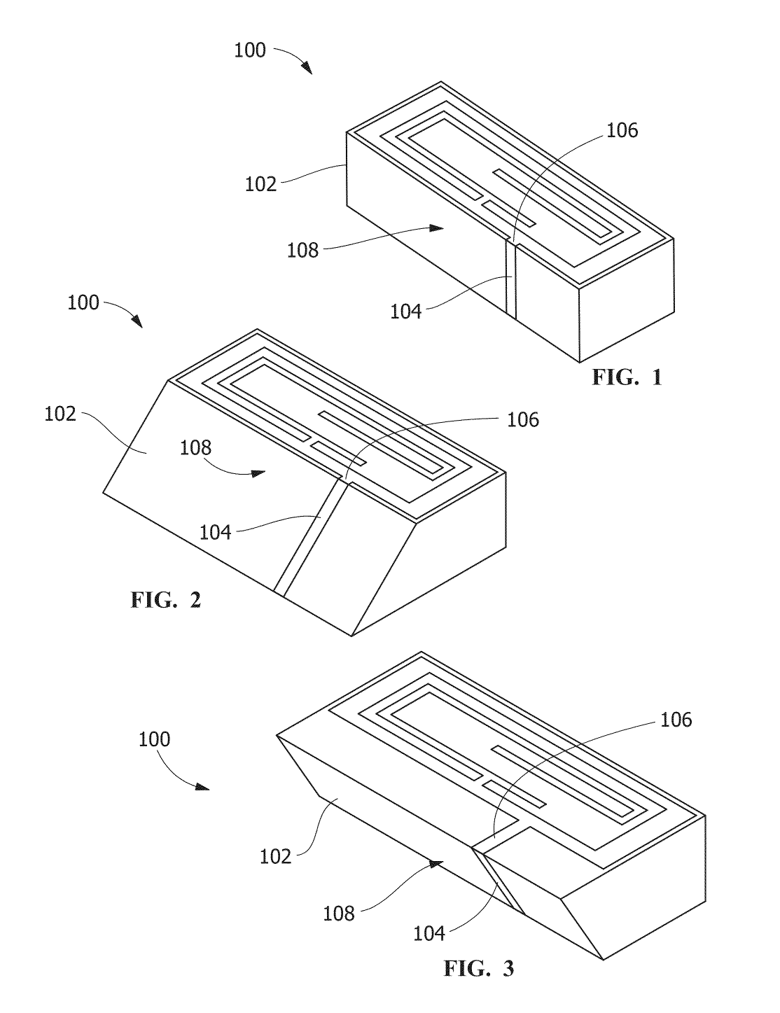

Referring to FIGS. 1-9, according to the disclosure, an article 100 includes a substrate 102 and a conductive pattern 104, such as, an antenna, a power trace, a resistive heater, a conductive lead, a sensor, a functional electrical device (for example, an active electrical device in contrast to a passive electrical device), other suitable conductive pattern, or a combination thereof. The article 100 is any suitable electronic device, such as, but not limited to, a radio frequency antenna, radio frequency circuits or components, two-way communication components, cellular components, radar components, casings for electronic components, or a combination thereof.

The substrate 102 is polymeric, a composite, metallic, metal, ceramic, thermoset, thermoplastic, glass, any other suitable rigid or flexible material, or a combination thereof. In one embodiment, the substrate 102 is selected from the group consisting of polyetherimide, p-polyphenylene sulfide (for example, with carbon fiber), polyether ether ketone, a blend of polyphenylene oxide and polystyrene, acrylonitrile butadiene styrene, a blend of polycarbonate and acrylonitrile butadiene styrene, and combinations thereof.

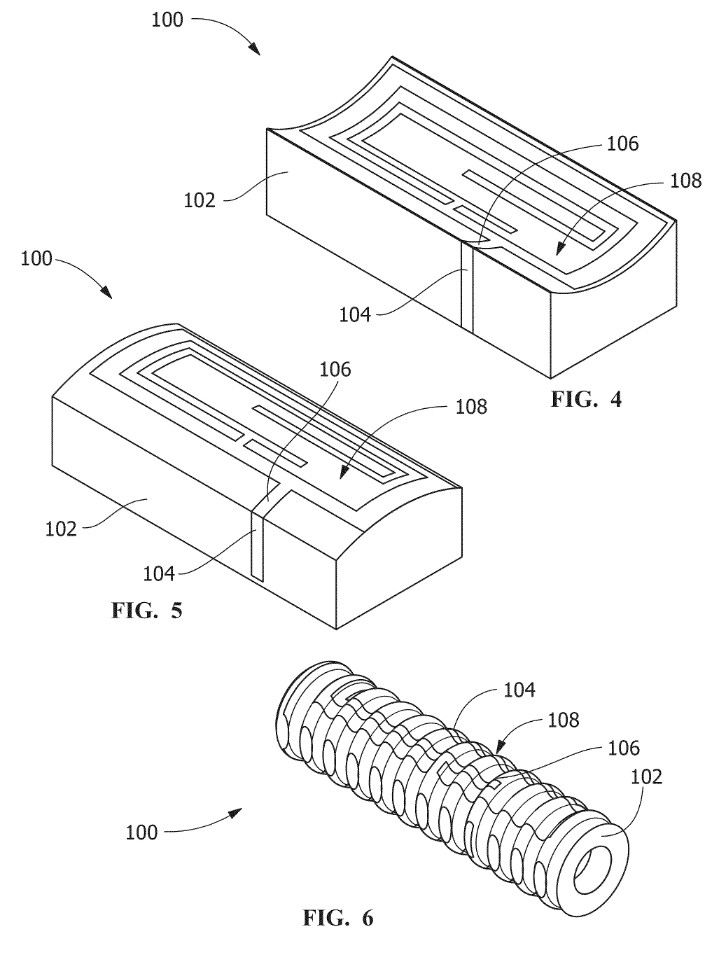

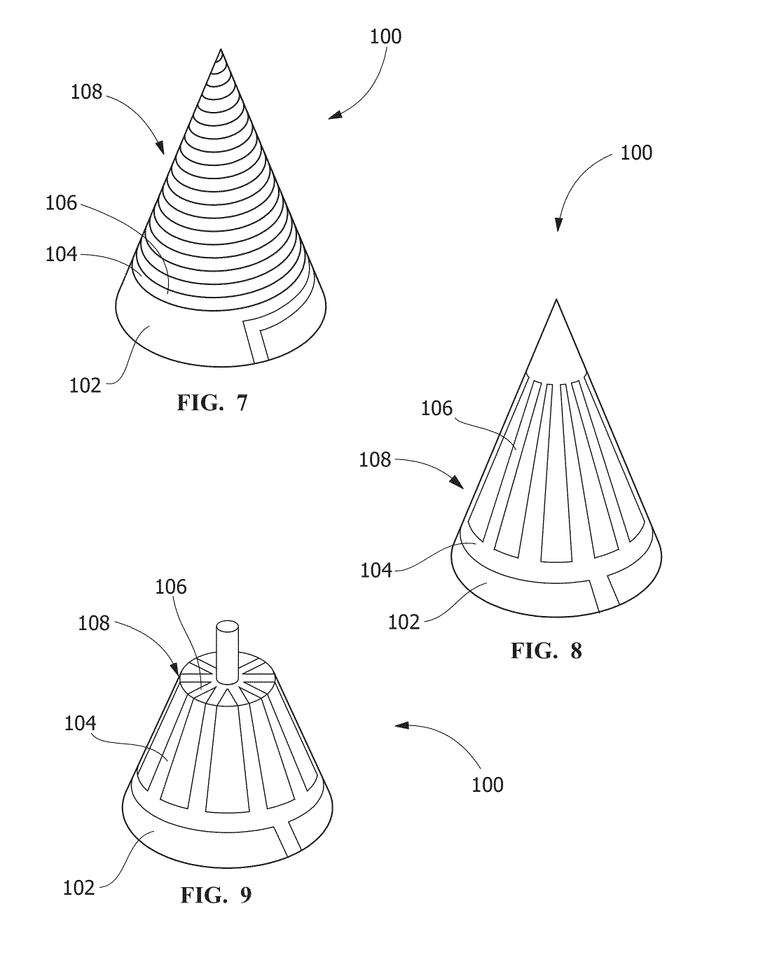

The conductive pattern 104 includes conductive ink 106. *****The conductive ink 106 extends over a non-planar region 108 of the substrate 102. The non-planar region 108 is any suitable geometry where all points do not reside in the same two dimensions (e.g. not flat). Suitable geometries include, but are not limited to, a 90-degree non-planar region (see FIG. 1), a 45-degree non-planar region (see FIG. 2), a 120-degree non-planar region (see FIG. 3), any other suitable angled non-planar region (for example, a 15-degree non-planar region, a 30-degree non-planar region, a 60-degree non-planar region, a 150-degree non-planar region, or a 165-degree non-planar region), a concave non-planar region (see FIG. 4), a convex non-planar region (see FIG. 5), a ribbed non-planar region (see FIG. 6), a conical non-planar region (see FIG. 7 showing an embodiment with a spiraling orientation and FIG. 8 showing an embodiment with a radial orientation), a frustoconical non-planar region (see FIG. 9), a faceted non-planar region, any other suitable geometry, or any suitable combination thereof.

In one embodiment, the conductive pattern 104 and/or the conductive ink 106 include at least a portion arranged as one or more traces, one or more ground paths, one or more bonding pads, any other suitable and accessible region, or a combination thereof. For example, in one embodiment, the conductive ink 106 is within the accessible region, the accessible region being capable of receiving the conductive ink 106 through line-of-sight spray techniques.

In one embodiment, the conductive ink 106 includes metal or metallic particulates in a polymer matrix. The metal or metallic particulates include or are silver, copper, nickel, silver-coated copper, other suitable conductive metals, or a combination thereof. The metal or metallic particulates include or are flakes, particles, rods, dendritic particles, particles having multiple form factors and/or aspect ratios, other suitable particles permitting conductivity within the conductive ink 106, or a combination thereof.

The conductive ink 106 includes any suitable concentration of conductive and non-conductive components. Suitable concentrations of polymer include being, by weight, between at or about 20% and at or about 40%, between at or about 30% and at or about 40%, between at or about 30% and at or about 35%, between at or about 25% and at or about 35%, at or about 33%, or any suitable combination, sub-combination, range, or sub-range therein. Suitable elemental concentrations of silver include being, by weight, between at or about 50% and at or about 80%, between at or about 60% and at or about 80%, between at or about 50% and at or about 70%, between at or about 65% and at or about 75%, between at or about 60% and at or about 70%, at or about 67%, or any suitable combination, sub-combination, range, or sub-range therein.

The metal or metallic particulates are of any suitable dimensions capable of being within the polymer matrix. Suitable dimensions include, but are not limited to, a maximum dimension (for example, of a dendritic particle) being between at or about 1 and at or about 10 micrometers, a maximum dimension being between at or about 5 and at or about 10 micrometers, a maximum dimension being between at or about 8 and at or about 10 micrometers, a longest axis (for example, of a flake) being between at or about 20 and at or about 50 micrometers, a longest axis being at between at or about 30 and at or about 50 micrometers, a longest axis being between at or about 40 and at or about 50 micrometers, a longest axis being at between at or about 20 and at or about 30 micrometers, or any suitable combination, sub-combination, range, or sub-range therein. In one embodiment, two or more of the metal or metallic particulates with varied dimensions and/or geometries are within the polymer matrix.

The polymer matrix includes epoxy, acrylic, thermoplastic, polyurethane, other suitable materials capable of suspending the metal particulates, other suitable polymers capable of being dissolved in solvent, or a combination thereof.

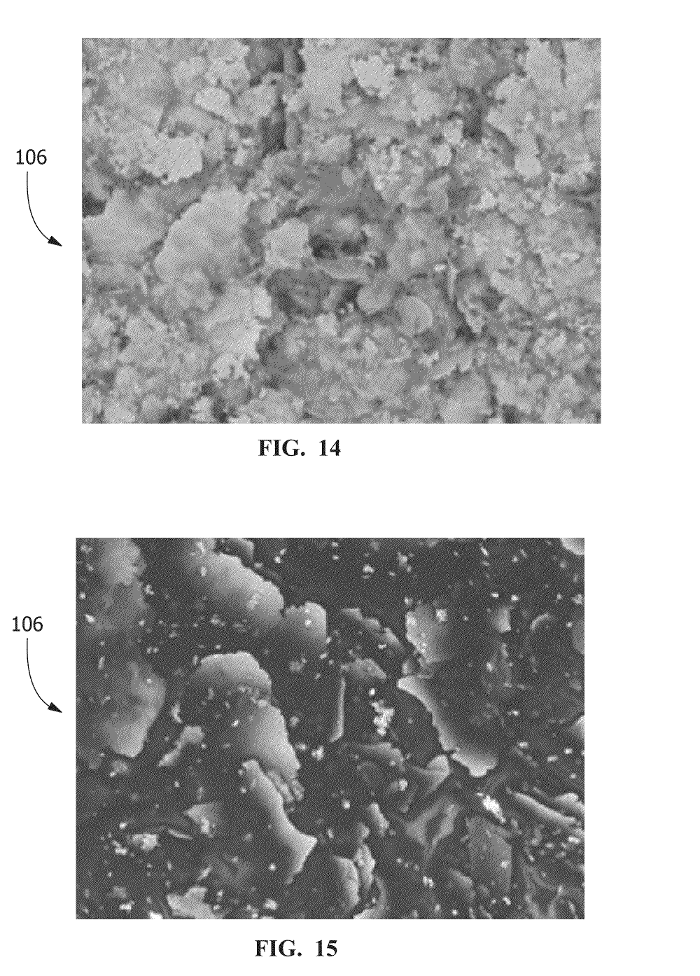

As a whole, the conductive ink 106 is any suitable material(s) capable of conducting within predetermined parameters through the non-planar region 108. FIGS. 14 and 15 display a scanning electron micrograph of embodiments of the conductive ink 106. In one embodiment, the conductive ink 106 includes silver-plated copper flakes and pure silver dendritic particles as the metal or metallic particulates within an acrylic polymer matrix in a homogenous suspension. In another embodiment, the conductive ink 106 includes silver as the metal or metallic particulate, epoxy as the polymer matrix, and a curative solution. In these embodiments, the conductive ink 106 is capable of being spray-applied using a high volume, low pressure spray device with atomizing air at between 138 kPa and 345 kPa. In a further embodiment, the conductive ink 106 has an average percentage of solids, by weight, of at or about 32%, 718 g/1 calculated volatile organic compounds, and a specific gravity between 0.9 and 1.3.

The conductive ink 106 generally conducts via percolation, for example, where electrons transfer by tunneling or other mechanisms between the metal or metallic particulates, which are conductive, within the polymer matrix, which includes resistive properties.

In one embodiment, the distance between the metal or metallic particulates corresponds to a suitable conductivity loss at the frequency of operation. Suitable frequencies include, but are not limited to, being between at or about 100 kHz and at or about 1 THz, between at or about 100 kHz and at or about 10 GHz, between at or about 100 kHz and at or about 100 MHz, between at or about 100 kHz and at or about 10 MHz, between at or about 100 kHz and at or about 1 MHz, between at or about 1 MHz and at or about 10 GHz, between at or about 10 MHz and at or about 10 GHz, between at or about 100 MHz and at or about 10 GHz, between at or about 10 GHz and at or about 1 THz, or any suitable combination, sub-combination, range, or sub range therein.

Suitable direct current (DC) resistivity values for the conductive ink 106 include, but are not limited to, being between at or about 4×10⁻⁷ and at or about 25×10⁻⁷ Ω·m, between at or about 12×10⁻⁷ and at or about 25×10⁻⁷ Ω·m, between at or about 0.2×10⁻⁷ and at or about 25×10⁻⁷ Ω·m, at or about 4×10⁻⁷ Ω·m, at or about 12×10⁻⁷ Ω·m, at or about 25×10⁻⁷ Ω·m, or any suitable combination, sub-combination, range, or sub-range therein.

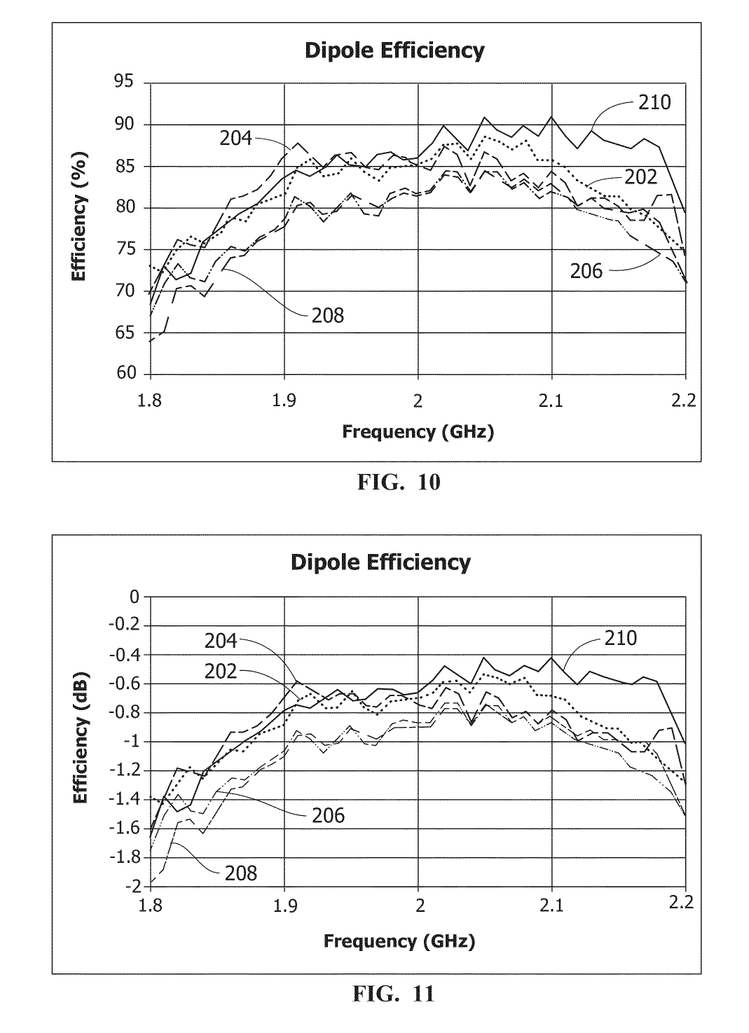

In one embodiment, the conductive ink 106 includes dipole efficiency matching an aluminum foil reference at 2 GHz and below, varying by an average of less than 0.1 dB. Additionally or alternatively, the conductive ink 106, at above 2 GHz, has a variance of dipole efficiency averaging less than 0.25 dB. In another embodiment, the dipole efficiency of the conductive ink 106 differs from the dipole efficiency of an aluminum foil reference by an average of 0.3 dB above and below 2 GHz. In further embodiments, the conductive ink 106 includes dipole efficiency, as shown in FIGS. 10-11 and/or the first example, described below.

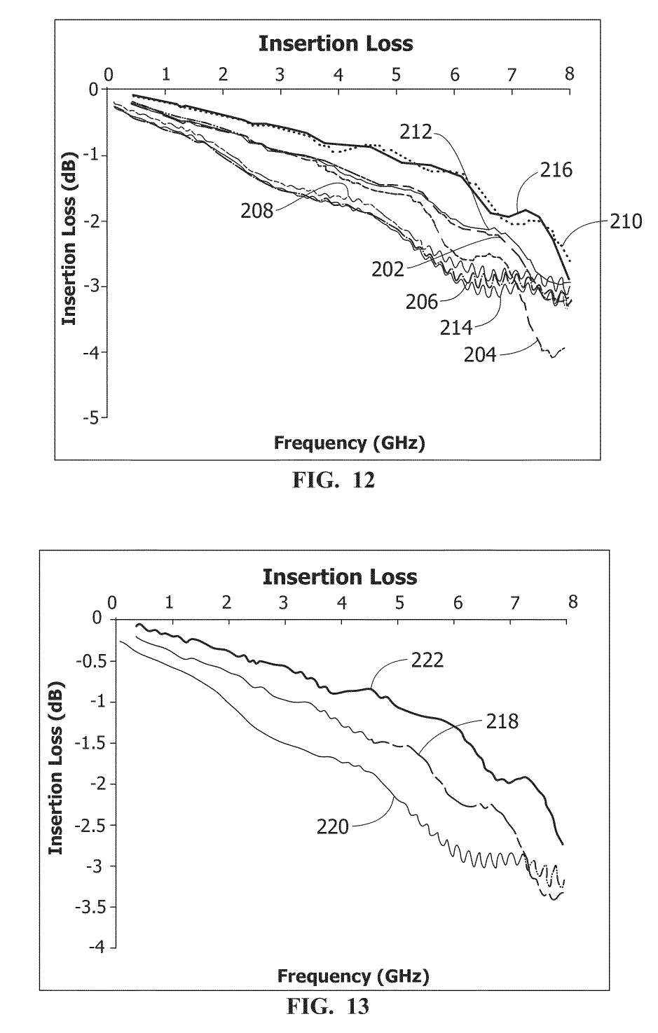

In one embodiment, the conductive ink 106 has insertion loss differing from an aluminum foil reference at 2 GHz by about 0.2 dB. In another embodiment, the conductive ink 106 has insertion loss being at a difference of about 0.75 dB at 2 GHz, in comparison to the aluminum foil reference. In further embodiments, the conductive ink 106 includes insertion loss, as shown in FIG. 12-13 and/or the first example, described below.

The conductive ink 106 is spray-applied by any suitable spray device, such as, an automotive paint sprayer, an atomizing sprayer, an aerosol sprayer, an ultrasonic sprayer, or a combination thereof. The conductive ink 106 is spray-applied in a single-pass application or with multiple-pass application.

The conductive ink 106 is spray-applied at any thickness capable of permitting the conductive ink 106 to conduct through the non-planar region 108. For example, in one embodiment, the conductive ink 106 is spray-applied at a thickness at, averaging, or between at or about 15 micrometers and at or about 25 micrometers, between at or about 15 micrometers and at or about 20 micrometers, between at or about 20 micrometers and at or about 25 micrometers, between at or about 20 micrometers and at or about 22 micrometers, between at or about 18 micrometers and at or about 22 micrometers, between at or about 18 micrometers and at or about 20 micrometers, between at or about 19 micrometers and at or about 21 micrometers, at or about 19 micrometers, at or about 20 micrometers, at or about 21 micrometers, or any suitable combination, sub-combination, range, or sub-range therein.

In one embodiment, the spray-applying of the conductive ink 106 establishes conductive traces and/or an antenna pattern by broad-area spray coating. A conformal shadow mask or adhesive mask is used to define the conductive traces through the non-planar region 108. The conformal shadow mask is a flexible or rigid material and is reusable or single-use, which is removed to define the conductive traces and/or antenna pattern. The conductive ink 106 is cured and the conformal mask is removed, revealing the conductive traces. Alternatively, the conformal mask can be removed from the conductive traces prior to curing of the conductive ink.

In one embodiment, the spray-applying of the conductive ink 106 includes using a computer-numerical control (CNC) laser system and a laser-markable tape to develop the conductive traces and/or antenna pattern. The laser-markable tape is sensitive to a laser and is spray-applied to the non-planar region 108 of the substrate 102. In one embodiment, the laser-markable tape is a polyester tape of less than 50 micrometers in thickness. The CNC laser system ablates the laser-markable tape to form a template for the conductive traces and/or antenna pattern. In one embodiment, portions of the laser-markable tape are then removed and/or additional portions are covered with tape or foil to prevent coating. The conductive ink 106 is then spray-applied and cured within the template to form the conductive traces and/or antenna pattern. Any remaining portions of the laser-markable tape are then removed.

In one embodiment, the spray-applying of the conductive ink 106 includes using the CNC laser system to directly form the conductive traces and/or the antenna pattern by laser ablation. In this embodiment, the conductive ink 106 is sensitive to a laser and is ablated by the laser, thereby forming non-conductive portions. In addition to or alternative to the laser ablation, other suitable ablation techniques are used. Suitable techniques include, but are not limited to, focused ion beam (FIB) milling, electron beam ablation, proton beam ablation, ultrasonic ablation, abrasive ablation (bead blasting), other suitable ablation processes providing suitable resolution, or a combination thereof.

In one embodiment, the spray-applying of the conductive ink 106 includes directly forming the conductive traces and/or the antenna pattern by ablation, using a pattern or program to define the non conductive regions. In this embodiment, the ablation pattern is communicated to the CNC laser system or other ablative tool by means of a computer program or drawing.

The non-conductive portions define the geometry of the conductive ink 106 on the non-planar region 108. In one embodiment, the laser ablation of the conductive ink 106 is performed after initial or partial curing of the conductive ink 106, for example, upon the conductive ink 106 being devoid or substantially devoid of solvent through solvent evaporating. In one embodiment, the conductive pattern 104 includes laser-ablated regions in a dielectric region 110 or substantially dielectric region defining at least a portion of a pattern of the conductive ink 106.

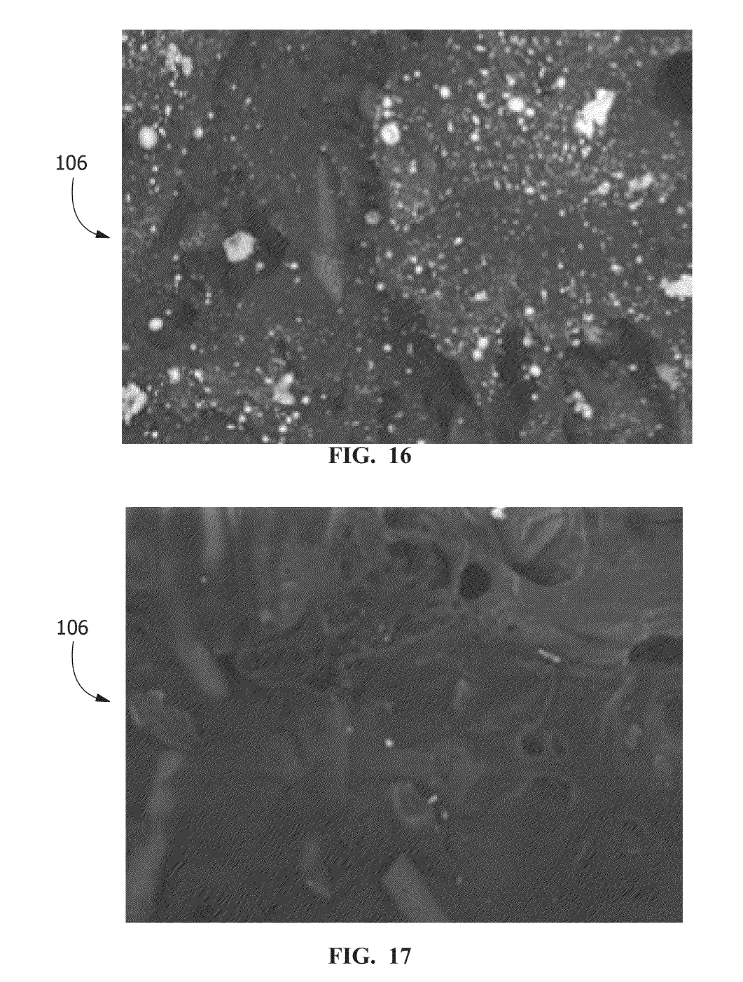

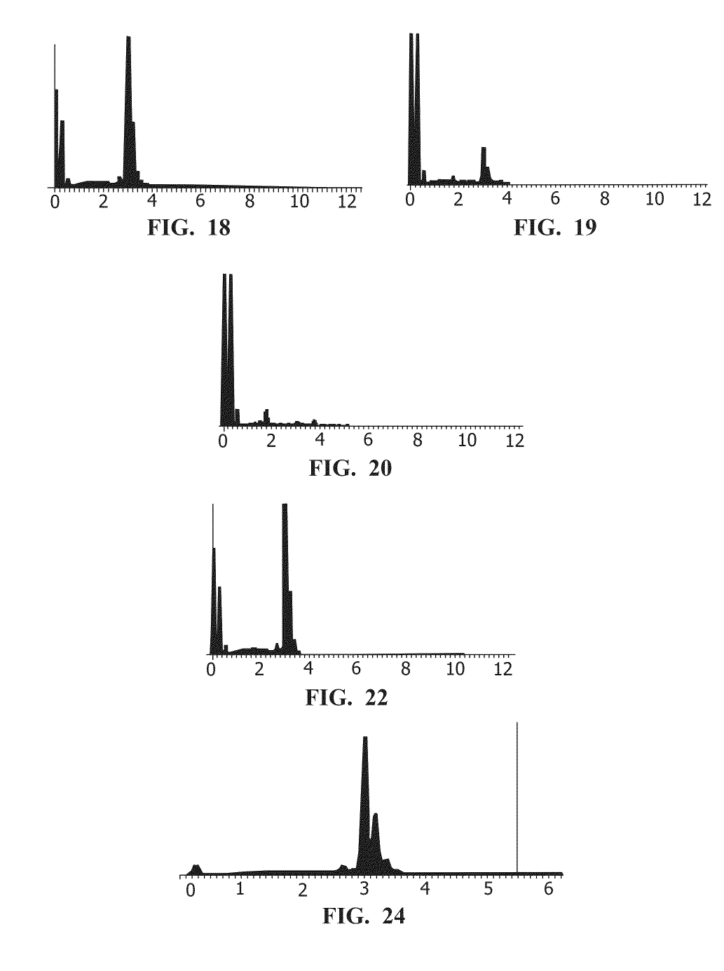

The laser ablation is within any suitable operational parameters and may be achieved in a single exposure to the laser, two exposures to the laser, three exposures to the laser, or more. FIG. 16 shows a scanning electron micrograph of an embodiment of the conductive ink 106 after a single pass of a laser. FIG. 17 shows a scanning electron micrograph of an embodiment of the conductive ink 106 after a second pass of the laser. A suitable power for each exposure is 16 W. A suitable frequency for the laser is 100 kHz. In one embodiment, the conductive ink 106 is further cured, for example, at a temperature of about 177° C. for about 1 hour, after the laser ablation. The laser ablation decreases the concentration of the conductive metal, for example, silver, in the ablated regions of the conductive ink 106. In one embodiment, the decrease in elemental concentration is, by weight, from 67% to 19% in a first pass and to 1.5% in a second pass. In further embodiments, the elemental concentration changes, as is shown in FIGS. 18-20 and/or as described in the second example, described below.

In one embodiment, the laser ablation of the conductive ink 106 results in 15.7 MΩ resistance and/or a depth of 4.5 micrometers after a first laser pass, 349 MΩ resistance and/or a depth of 11.1 micrometers after a second laser pass, 513 MΩ resistance and/or a depth of 24.7 micrometers after a third laser pass, 345 MΩ resistance and/or a depth of 66.6 micrometers after a fourth laser pass, 333 MΩ resistance and/or a depth of 83.9 micrometers after a fifth laser pass, or a combination thereof. In one embodiment, the laser ablation of the conductive ink 106 results in a resistance increase to the MΩ range (10⁶Ω) and/or a depth of 4.5 micrometers after a first laser pass, an increase to the 100 MΩ range (10⁸Ω) and/or a depth of 11.1 micrometers after a second laser pass, and further resistance increases for additional passes, as well as a depth of 24.7 micrometers after a third laser pass, 1 a depth of 66.6 micrometers after a fourth laser pass, and a depth of 83.9 micrometers after a fifth laser pass, or a combination thereof. Additionally or alternatively, the first laser pass, the second laser pass, and/or additional laser passes of the laser ablation of the conductive ink 106 result in increases in resistance of between at or about 100 MΩ and at or about 200 MΩ, between at or about 100 MΩ and at or about 300 MΩ, between at or about 200 MΩ and at or about 300 MΩ, at least 100 MΩ, at least 200 MΩ, at least 300 MΩ, or any suitable combination, sub-combination, range, or sub-range therein.

In one embodiment, the spray-applying of the conductive ink 106 includes using the CNC laser system to directly form the conductive traces and/or the antenna pattern by selective photo-sintering, for example, of a metallic filler in the conductive ink 106. In this embodiment, the conductive ink 106 is spray-applied to the non-planar region 108 of the substrate 102 and the conductive ink 106 is devoid or substantially devoid of solvent through solvent evaporating. The laser then melts and/or fuses the metallic filler and ablates the polymer matrix to form the conductive traces and/or the antenna pattern. The conductive ink 106 is then washed, for example, with solvent (such as 2-butanone followed by acetone), to remove portions that have not been exposed to the laser, revealing the conductive traces and/or the antenna pattern.

The selective photo-sintering is within any suitable operational parameters and is capable of being achieved in a single exposure to the laser, two exposures to the laser, three exposures to the laser, four exposures to the laser, five exposures to the laser, or more. A suitable power for each exposure is 3 W. A suitable frequency for the laser is 200 kHz. The selective photo-sintering increases the concentration of the conductive metal, for example, silver, in the conductive ink 106. In one embodiment, the increase is, by weight, from 66% to at or about 92%. In a further embodiment, the concentration of the conductive ink 106 includes the elemental concentration or elemental differentials between a first composition, by weight, of at or about 22% C, at or about 11% O, and at or about 67% Ag, and a second composition, by weight, of at or about 5% C, at or about 2.2% O, at or about 0.3% Mg, and at or about 92% Ag. Additionally or alternatively, the selective photo-sintering increases the concentration, by weight, of the silver by between at or about 20% and at or about 40%, between at or about 20% and at or about 30%, between at or about 25% and at or about 30%, at or about 10% or more, at or about 20% or more, at or about 25% or more, or any suitable combination, sub-combination, range, or sub-range therein. Additionally or alternatively, the selective photo-sintering decreases the concentration, by weight, of the carbon by between at or about 10% and at or about 20%, between at or about 10% and at or about 15%, at or about 10% or more, at or about 15% or more, or any suitable combination, sub-combination, range, or sub-range therein.

The laser used for embodiments of the spray-applying of the conductive ink 106 are any suitable laser capable of achieving operational parameters, for example, power and frequency to achieve the increase and/or the decrease in conductivity/resistivity. Suitable lasers include, but are not limited to, an Nd:YAG laser, an Nd:YVO₄ laser, an Nd:YLF laser, a Yb:YAG laser, a Yb:KGW laser, a Yb:KYW laser, a Yb:SYS laser, a Yb:BOYS laser, a Yb:CaF₂ laser, other suitable lasers having sufficient power, frequency, and/or wavelength, or a combination thereof. In one embodiment, the laser operates at a selected wavelength, such as, between at or about 1,020 nm and at or about 1,070 nm, between at or about 1,020 nm and at or about 1,050 nm, between at or about 1,050 nm and at or about 1,070 nm, at or about 1,020 nm, at or about 1,050 nm, at or about 1,064 nm, or any suitable combination, sub-combination, range, or sub-range therein.

### Examples

In a first example, dipole antenna and transmission line samples are deposited using a first conductive ink having silver flakes and particulate in an epoxy, a second conductive ink having silver-coated copper flakes and dendritic silver particles in an acrylic, a third conductive ink having silver-coated copper flakes in an epoxy, and a fourth conductive ink having copper particulate in a polyurethane. The first conductive ink has a resistivity of 7×10⁻⁷ Ω·m. The second conductive ink has a resistivity of 12×10⁻⁷ Ω·m. The third conductive ink has a resistivity of 83×10⁻⁷ Ω·m. The fourth conductive ink has a resistivity of 1.7×10⁻⁵ Ω·m. A scanning electron micrograph of the first conductive ink is shown in FIG. 14 and a scanning electron micrograph of the second conductive ink is shown in FIG. 15.

FIGS. 10 and 11 show the dipole efficiency for a first sample 202 from the first conductive ink, a second sample 204 from the first conductive ink, a third sample 206 from the second conductive ink, a fourth sample 208 from the second conductive ink, and an aluminum foil reference 210. The first sample 202 and the second sample 204 match the aluminum foil reference 210 very precisely at 2 GHz and below, varying from aluminum foil reference 210 by an average of less than 0.1 dB. Above 2 GHz, the first sample 202 and the second sample 204 vary by an average of less than 0.25 dB. The third sample 206 and the fourth sample 208 differ from the aluminum foil reference 210 by being an average of 0.3 dB lower throughout the frequency range.

FIGS. 12 and 13 show insertion loss data. FIG. 12 shows data for the first sample 202, the second sample 204, the third sample 206, the fourth sample 208, and the aluminum foil reference 210. In addition, FIG. 12 show insertion loss data for a fifth sample 212 having the first conductive ink, a sixth sample 214 having the second conductive ink, and a second aluminum foil reference 216. FIG. 13 shows averages of the insertion loss data as a first conductive ink sample average 218, a second conductive ink sample average 220, and an aluminum foil reference sample average 222. At 2 GHz, there is a difference of about 0.2 dB between the first conductive ink sample average 218 and the second conductive ink sample average 220 in comparison to the aluminum foil reference sample average 222, which is consistent with the measured antenna efficiency for a similar-length antenna. The second conductive ink sample average 218 shows a difference of about 0.75 dB at 2 GHz.

In a second example, laser ablation of the first conductive ink is analyzed. FIG. 16 shows a scanning electron micrograph of the first conductive ink after a single pass of a laser. Some silver particles remain. FIG. 17 shows a scanning electron micrograph of the first conductive ink after a second pass of the laser. No or substantially no silver particles remain. FIGS. 18-20 show energy-dispersive X-ray spectra of the first conductive film before ablation (see FIG. 18), after the single pass of the laser (see FIG. 19), and after the second pass of the laser (see FIG. 20).

As shown in FIG. 18, the first conductive ink begins with an elemental concentration, by weight, of 22% C, 11% O, and 67% Ag. As shown in FIG. 19, after the first pass, the first conductive ink has an elemental concentration, by weight, of 60% C, 20% O, and 19% Ag. As shown in FIG. 20, after the second pass, the first conductive ink has an elemental concentration 72% C, 23% O, and 1.5% Ag.

Laser ablation of the first conductive ink also impacts resistance. Measuring with a Kelvin probe for resistance and using stylus profilometry for depth, after the first pass of the laser to be 15.7 MΩ at a depth of 4.5 micrometers. After the second pass of the laser, the resistance is 349 MΩ at a depth of 11.1 micrometers. After a third pass of the laser, the resistance is 513 MΩ at a depth of 24.7 micrometers. After a fourth pass of the laser, the resistance is 345 MΩ at a depth of 66.6 micrometers. After a fifth pass of the laser, the resistance is 333 MΩ at a depth of 83.9 micrometers.

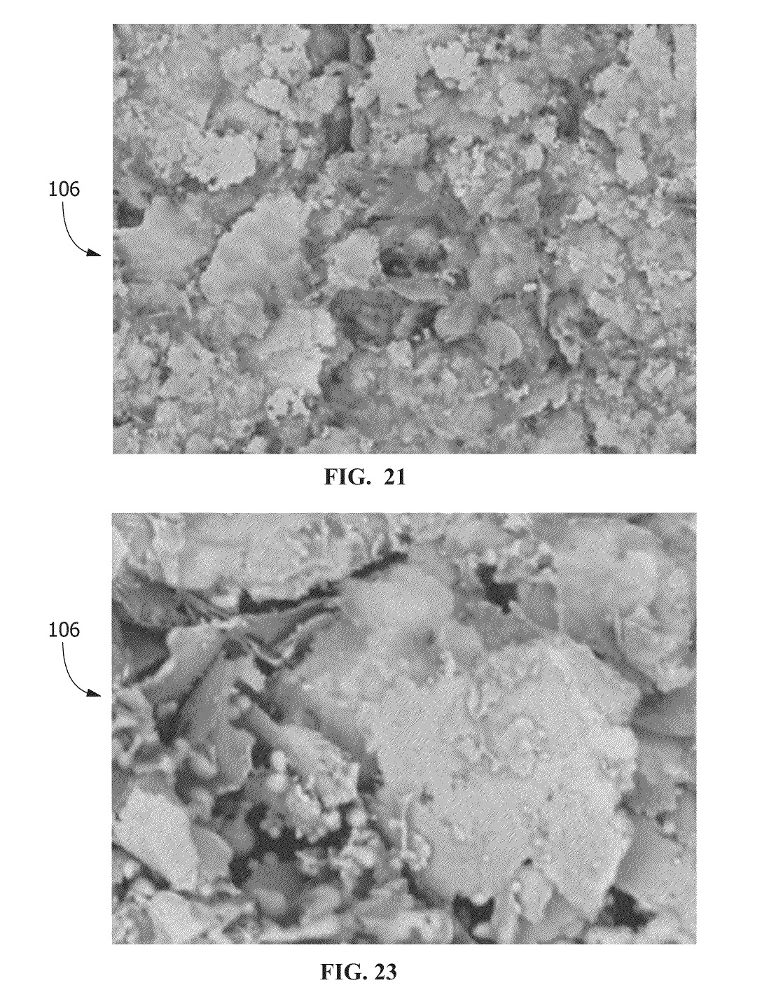

In a third example, a conductive ink having a metallic filler comprising flake and dendritic particles is photo-sintered. FIG. 21 shows a scanning electron micrograph of the conductive ink before photo-sintering. FIG. 22 shows an energy-dispersive X-ray spectra of the conductive ink before photo-sintering. FIG. 23 shows a scanning electron micrograph of the conductive ink after photo-sintering. FIG. 24 shows an energy-dispersive X-ray spectra of the conductive ink after photo-sintering. Comparing FIGS. 21 and 23 shows that photo-sintering melts the metallic filler. Comparing FIGS. 22 and 24 shows an increase in silver concentration, with FIG. 22 showing an elemental concentration, by weight, of 22% C, 11% O, and 67% Ag, while FIG. 23 shows an elemental concentration, by weight, of 5% C, 2.2% O, 0.3% Mg, and 92% Ag.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process, comprising:
providing a substrate;
spray-applying conductive ink onto a non-planar region of the substrate; and
ablating the conductive ink or photo-sintering the conductive ink.

2. The process of claim 1, further comprising curing the conductive ink by selective laser curing.

3. The process of claim 1, wherein the ablating of the conductive ink is laser ablation.

4. The process of claim 3, wherein the laser ablation is with at a wavelength between 1,020 nm and 1,070 nm.

5. The process of claim 3, wherein the laser ablation is with an Nd:YAG laser, an Nd:YVO₄ laser, an Nd:YLF laser, a Yb:YAG laser, a Yb:KGW laser, a Yb:KYW laser, a Yb:SYS laser, a Yb:BOYS laser, a Yb:CaF₂ laser, or a combination thereof.

6. The process of claim 3, wherein the laser ablating decreases elemental concentration of a metallic conductor within the conductive ink, by weight, by a difference of over 40% in a single pass and by a difference of over 60% in two passes.

7. The process of claim 3, wherein the laser ablating increases resistivity of the conductive ink to at least 1×10⁷Ω in a first pass.

8. The process of claim 3, wherein the laser ablating increases resistivity of the conductive ink by at least 3×10⁸Ω in two passes.

9. The process of claim 3, wherein the laser ablating completely removes a region of the conductive ink to form a non-conductive region.

10. The process of claim 3, wherein the laser ablating completely partially removes a region of the conductive ink.

11. The process of claim 3, wherein the laser-ablating is at a power of 16 W and frequency of 100 kHz.

12. The process of claim 1, wherein the ablating of the conductive ink is focused ion beam ablation, electron beam ablation, proton beam ablation, ultrasonic ablation, abrasive ablation, or a combination thereof.

13. The process of claim 1, further comprising photo-sintering the conductive ink, wherein the conductive ink includes a metallic filler, the metallic filler melted by the photo-sintering.

14. The process of claim 13, wherein the photo-sintering is at a power of 3 W and a frequency 200 kHz.

15. The process of claim 13, wherein the photo-sintering increases elemental concentration of a metallic conductor, by weight, by a difference over 20%.

16. The process of claim 13, wherein the photo-sintering decreases elemental concentration of carbon, by weight, by a difference over 15%.

17. The process of claim 13, wherein the photo-sintering modifies the elemental concentration of the conductive ink, by weight, from a first composition having 33% polymer matrix and 67% Ag to a second composition having 8% polymer matrix and 92% Ag.

18. The process of claim 1, further comprising conformal shadow-masking prior to the spray-applying of the conductive ink, wherein the spray-applying of the conductive ink after the conformal shadow-masking defines conductive traces through the non-planar region.

19. A process of fabricating an antenna, the process comprising:
providing a substrate; and
spray-applying conductive ink onto a non-planar region of the substrate to form at least a portion of the antenna.

20. A process, the process comprising:
providing a substrate; and
spray-applying conductive ink onto a non-planar region;
wherein the conductive ink has an elemental composition, by weight, of 23% polymer matrix and 67% Ag.
